(19) United States
(12) Patent Application Publication
(10) Pub. No.: US 2014/0159693 A1
(43) Pub. Date: Jun. 12, 2014

(54) STEP-DOWN SWITCHING MODE POWER SUPPLY AND THE METHOD THEREOF

(71) Applicant: Chengdu Monolithic Power Systems Co., Ltd., Chengdu (CN)

(72) Inventors: Naixing Kuang, Hangzhou (CN); Bo Yu, Hangzhou (CN); Jiaqi Yu, Hangzhou (CN); Qiaoan Zuo, Hangzhou (CN)

(73) Assignee: CHENGDU MONOLITHIC POWER SYSTEMS CO., LTD., Chengdu (CN)

(21) Appl. No.: 14/102,098

(22) Filed: Dec. 10, 2013

(30) Foreign Application Priority Data
Dec. 10, 2012 (CN) 201210528903.8

(51) Int. Cl. H02M 3/156

(52) U.S. Cl. CPC H02M 3/156
USPC 323/285

(57) ABSTRACT

A step-down switching mode power supply having: a Buck converter configured to provide power to a load, wherein the Buck converter has a power switch and an energy storage component; a current sense circuit coupled to the power switch to generate a current sense signal; a square circuit configured to generate a first multiply signal indicating the squared value of the input voltage; a multiply circuit configured to generate a product signal based on the first multiply signal and a second multiply signal; a current comparison circuit configured to generate a current comparison signal based on the current sense signal and the product signal; and a logic circuit configured to control the power switch.

### CROSS-REFERENCE TO RELATED APPLICATION(S)

This application claims priority to and the benefit of Chinese Patent Application No. 201210528903.8, filed Dec. 10, 2012, which is incorporated herein by reference in its entirety.

### TECHNICAL FIELD

The present invention relates generally to electric circuits, and more particularly but not exclusively to step-down switching mode power supply and the method thereof.

### BACKGROUND

Switching mode power supplies are widely used to supply power to electric devices. Normally, a rectifier is plugged to grid to obtain an AC voltage and then convert the AC voltage to a rectified voltage. After that, a switching mode power supply converts the rectified voltage to a desired DC voltage to power the electric device.

However, the widely application of the switching mode power supply injects more and more harmonic current to the grid. The high-order harmonic currents increase the power consumption and meanwhile decrease the power factor of a system. Moreover, the high-order harmonic currents influence the quality and the reliability of the grid. In severe case, the harmonic currents may false trig relay protection and burn circuit board, electric meter, or other devices. Thus, it is important for switching mode power supply to decrease the harmonic currents and meanwhile increase the power factor so as to improve the efficiency.

A common PFC (Power Factor Correction) method of the switching mode power supply is to make the envelope of the peak of the input current follow the input voltage. For step-up switching mode power supplies with continuous input current, e.g., the boost converter, the waveform of the input current is sinusoidal and is in phase with the voltage provided by the grid if the envelope of the peak of the input current follows the input voltage. But for step-down switching mode power supplies with discontinuous input current, e.g. the buck converter, the waveform of the input current is not sinusoidal and is not in phase with the voltage provided by the grid even if the envelope of the peak of the input current follows the input voltage.

FIGS. 1 and 2 show the waveforms of signals in a prior step-down switching mode power supply, wherein Iin represents the input current, Ipk represents the envelope of the peak of the input current, CTRL represents a control signal of a power switch of the step-down switching mode power supply, and lave represents the average of the input current. As can be seen from FIGS. 1 and 2, the average lave of the input current is not sinusoidal when the envelope of the peak of the input current Ipk is sinusoidal. Thus, there will be many harmonic components in the input current, and the THD (Total Harmonic Distortion) is high. As a result, the power factor of the step-down switching mode power supply is influenced.

### SUMMARY

It is an object of the present invention to provide a step-down switching mode power supply with low THD and high power factor and the method thereof.

In accomplishing the above and other objects, there has been provided, in accordance with an embodiment of the present invention, a step-down switching mode power supply comprising: a Buck converter having an input terminal configured to receive an input voltage, an output terminal configured to provide power to a load, and a control terminal configured to receive a control signal to regulate the power provided to the load, wherein the Buck converter comprises a power switch and an energy storage component storing or transferring energy as the power switch is turned ON or OFF; a current sense circuit coupled to the power switch to generate a current sense signal based on a current flowing through the power switch; a square circuit having an input terminal configured to receive the input voltage, and an output terminal configured to generate a first multiply signal indicating the squared value of the input voltage; a multiply circuit having a first input terminal coupled to the square circuit to receive the first multiply signal, a second input terminal configured to receive a second multiply signal, and an output terminal configured to generate a product signal based on the first multiply signal and the second multiply signal; a current comparison circuit having a first input terminal coupled to the current sense circuit to receive the current sense signal, a second input terminal coupled to the multiply circuit to receive the product signal, and an output terminal configured to generate a current comparison signal based on the current sense signal and the product signal; and a logic circuit coupled between the output terminal of the current comparison circuit and the control terminal of the Buck converter, wherein the power switch is turned OFF by the logic circuit when the current sense signal is larger than or equal to the product signal.

Furthermore, there has been provided, in accordance with an embodiment of the present invention, a method of controlling a step-down switching mode power supply, the method comprising: sampling an input voltage of the Buck converter to generate an input voltage sample signal; sensing a current flowing through the power switch to generate a current sense signal; squaring the input voltage sample signal to generate a first multiply signal; multiplying the first multiply signal with a second multiply signal to generate a product signal based thereupon; comparing the current sense signal with the product signal; and turning OFF the power switch when the current sense signal is larger than or equal to the product signal.

The average of the input current of the step-down switching mode power supply is regulated to follow the input voltage of the step-down switching mode power supply, so as to achieve low THD and high power factor.

### BRIEF DESCRIPTION OF THE DRAWINGS

FIGS. 1 and 2 show the waveforms of signals in a prior step-down switching mode power supply.

FIG. 3 schematically shows a block of the step-down switching mode power supply 300 in accordance with an embodiment of the present invention.

FIG. 4 schematically shows a step-down switching mode power supply 400 in accordance with an embodiment of the present invention.

FIG. 5 schematically shows a peak current sample circuit 409 in accordance with an embodiment of the present invention.

FIG. 6 shows a flowchart of a method of controlling a step-down switching mode power supply in accordance with an embodiment of the present invention.

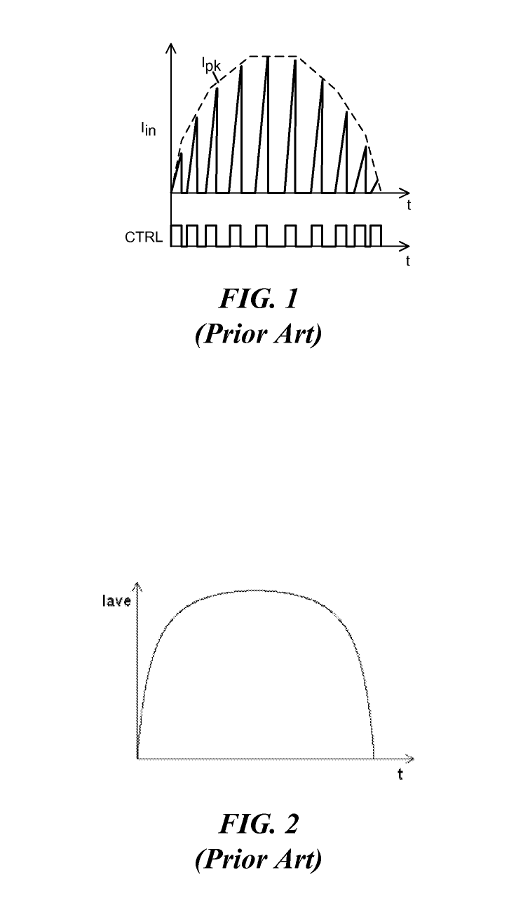

The use of the same reference label in different drawings indicates same or like components.

### DETAILED DESCRIPTION

In the present invention, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

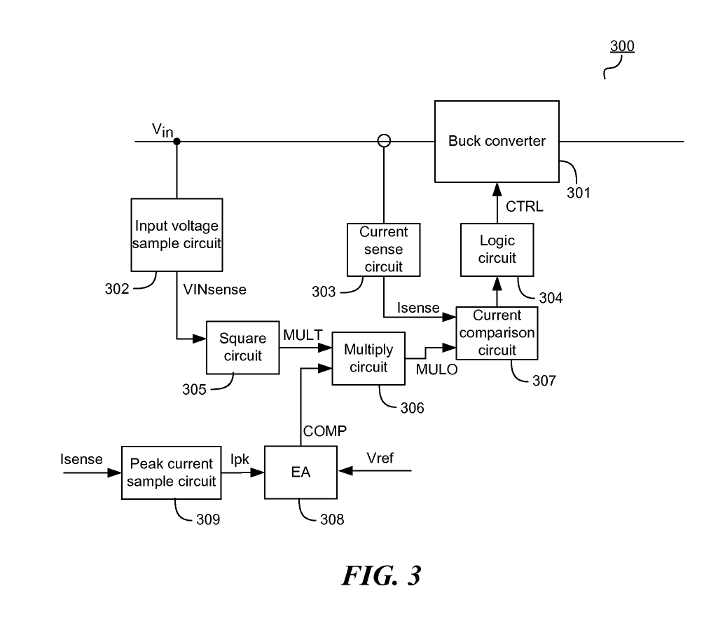

FIG. 3 shows a schematically block of the step-down switching mode power supply 300 in accordance with an embodiment of the present invention. As shown in FIG. 3, the step-down switching mode power supply 300 comprises: a buck converter 301, an input voltage sample circuit 302, a current sense circuit 303 and a control circuit. The buck converter 301 having an input terminal configured to receive an input voltage Vin, an output terminal configured to provide power to a load, and a control terminal configured to receive a control signal CTRL to regulate the power provided to the load, wherein the buck converter 301 comprises a power switch and an energy storage component coupled in series, and wherein the energy storage component stores energy when the power switch is ON, and transfers energy to the load when the power switch is OFF. Any normal buck converter could be adopted without detracting from the merits of the present invention. The schematic of the buck converter is well known by persons of ordinary skill in the art, and is not described here for brevity. The power switch of the buck converter 301 may be any controllable semiconductor devices, e.g., MOSFET (Metal Oxide Semiconductor Field Effect Transistor), IGBT (Isolated Gate Bipolar Transistor) and so on.

The input voltage sample circuit 302 is configured to receive the input voltage Vin, and to provide an input voltage sample signal VINsense based on the input voltage Vin. The current sense circuit 303 is coupled to the power switch of the buck converter 301 to generate a current sense signal Isense based on a current flowing through the power switch.

The control circuit is configured to provide a control signal CTRL to a gate terminal of the power switch. The control circuit comprises a square circuit 305, a multiply circuit 306, a current comparison circuit 307 and a logic circuit 304. The square circuit 305 is coupled to the input voltage sample circuit 302 to receive the input voltage sample signal VINsense. The square circuit 305 performs square operation on the input voltage sample signal VINsense to generate a first multiply signal MULT. The multiply circuit 306 is coupled to the input voltage sample circuit 305 to receive the first multiply signal MULT. The multiply circuit 306 multiplies the first multiply signal MULT with a second multiply signal to generate a product signal MULO. The current comparison circuit 307 is coupled to the current sense circuit 303 and the multiply circuit 306 to compare the current sense signal Isense with the product signal MULO. The logic circuit 304 is coupled between the gate terminal of the power switch and the current comparison circuit 307. The power switch is turned OFF when the current sense signal Isense is larger than or equal to the product signal MULO. In one embodiment, the second multiply signal is a compensation signal indicating output voltage/output current/output power of the step-down switching mode power supply 300.

The step-down switching mode power supply 300 may work under CCM (Continuous Current Mode), DCM (Discontinuous Current Mode) or BCM (Boundary Current Mode). In one embodiment, the step-down switching mode power supply 300 works under BCM, and the power switch is turned ON by the logic circuit when the current flowing through the energy storage component decreases to zero. The zero crossing detection could be achieved by detecting the voltage across the power switch or by other ways.

In one embodiment, by controlling the peak of the current flowing through the power switch follow with the first multiply signal MULT, i.e., the square of the input voltage sample signal VINsense, an average input current of the step-down switching mode power supply has a similar waveform with the input voltage. More specifically, the average input current and the input voltage of the step-down switching mode power supply both have the rectified sinusoidal waveform, and are in phase with each other. As a result, the harmonic components are reduced, so that THD is low and power factor is high.

In one embodiment, the step-down switching mode power supply 300 further comprises a peak current sample circuit 309 and an error amplifier 308. The peak current sample circuit 309 is coupled to the current sense circuit 303 to receive the current sense signal Isense, and based on the current sense signal Isense, the peak current sample circuit 309 generates a peak current signal Ipk. The error amplifier 308 amplifies the error between the peak current signal Ipk and a reference signal Vref to generate a compensation signal COMP. In one embodiment, the compensation signal COMP may be processed by adding with other signals, e.g., ramp signal, DC signal and so on.

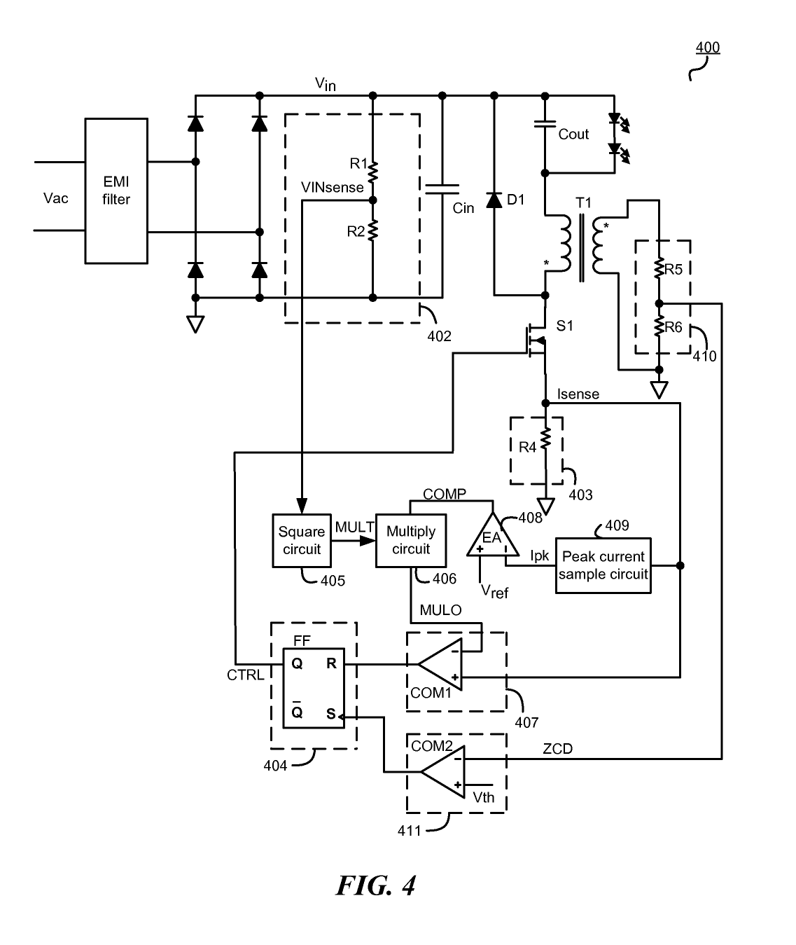

FIG. 4 schematically shows a step-down switching mode power supply 400 in accordance with an embodiment of the present invention. The step-down switching mode power supply 400 may be applied to drive LED strings. The step-down switching mode power supply 400 comprises an EMI filter, a rectifier, a buck converter, an input voltage sample circuit 402, a current sense circuit 403, a square circuit 405, a multiply circuit 406, a current comparison circuit 407, an error amplifier 408, a peak current sample circuit 409, a zero crossing detect circuit 410, a voltage comparison circuit 411 and a logic circuit 404. The buck converter comprises an input capacitor Cin, a transformer T1, a power switch S1, a power diode D1 and an output capacitor Gout.

The rectifier receives an AC voltage Vac from the grid via the EMI filter, and converts the AC voltage Vac to a rectified signal Vin. The input capacitor Cin has a first terminal coupled to the rectifier to receive the rectified signal, and a second terminal coupled to a reference ground. The power diode D1 has a cathode terminal coupled to the first terminal of the input capacitor Cin and an anode terminal coupled to the connection node of the transformer T1 and the power switch S1. The transformer T1 has a primary winding and a secondary winding, wherein the primary winding has a first terminal coupled to the output terminal of the rectifier and a second terminal coupled to the power switch S1. In one embodiment, the power switch S1 comprises NMOS (N type MOSFET). The power switch S1 has a drain terminal coupled to the second terminal of the primary winding of the transformer T1, a source terminal coupled to the reference ground, and a gate terminal coupled to the logic circuit 404 to receive the control signal CTRL. The output capacitor Cout has a first terminal coupled to the cathode terminal of the power diode D1 and a second terminal coupled to the first terminal of the primary winding. A LED string is coupled in parallel with the output capacitor Cout as the load of the step-down switching mode power supply 400. In one embodiment, the power diode D1 may be replaced by a MOSFET.

The input voltage sample circuit 402 comprises a voltage divider consisting of resistors R1 and R2. The voltage divider generates the input voltage sample signal VINsense based on the input voltage Vin. The current sense circuit 403 comprises a resistor R4 coupled between the source terminal of the power switch S1 and the reference ground. The current sense circuit 403 generates the current sense signal Isense based on the current flowing through the power switch S1. Persons of ordinary skill in the art should know that the voltage divider may be omitted if the input voltage Vin is within the input range of the multiply circuit 406.

The square circuit 405 is coupled to the input voltage sample circuit 402 to receive the input voltage sample signal VINsense, and then performs square operation on the input voltage sample signal VINsense to generate the first multiply signal MULT. The multiply circuit 406 has a first input terminal coupled to the multiply circuit 306 to receive the first multiply signal MULT, a second input terminal configured to receive the second multiply signal, and an output terminal configured to generate a product signal MULO representing the product value of the first multiply signal MULT and the second multiply signal. The peak current sample circuit 409 has an input terminal configured to receive the current sense signal Isense, and an output terminal configured to generate a peak current signal Ipk indicative of the peak of the current sense signal Isense. The error amplifier 408 has a first input terminal (non-inverting terminal) coupled to receive the reference signal Vref, a second input terminal (inverting terminal) coupled to the peak current sample circuit 409 to receive the peak current signal Ipk, and an output terminal configured to generate the compensation signal COMP based on the reference signal Vref and the peak current signal Ipk. The compensation signal COMP is adopted as the second multiply signal.

The current comparison circuit 407 has a first input terminal coupled to the current sense circuit 403 to receive the current sense signal Isense, a second input terminal coupled to the multiply circuit 406 to receive the product signal MULO, and an output terminal configured to provide a current comparison signal based on the current sense signal Isense and the product signal MULO. The zero crossing detect circuit 410 comprises a voltage divider consisting of a resistor R5 and a resistor R6 coupled in series. The voltage divider is coupled in parallel with the secondary winding to generate the zero crossing detect signal ZCD. The voltage comparison circuit 411 has a first input terminal coupled to the zero crossing detect circuit 410 to receive the zero crossing detect signal ZCD, and a second input terminal configured to receive a threshold signal Vth, and an output terminal configured to generates a voltage comparison signal based on the zero crossing detect signal ZCD and the threshold signal Vth. The logic circuit 404 has a first input terminal coupled to the current comparison circuit 407, a second input terminal coupled to the voltage comparison circuit 411, and an output terminal configured to provide the control signal CTRL to the gate terminal of the power switch S1 to turn ON and OFF the power switch S1 based on the output signals of the current comparison circuit 407 and the voltage comparison circuit 411. The first power switch S1 is turned ON when the zero crossing detect signal ZCD is lower than or equal to the threshold signal Vth, and is turned OFF when the current sense signal Isense is larger than or equal to the product signal MULO. In one embodiment, the threshold signal Vth has a value of zero. When the zero crossing detect signal ZCD decreases to zero, the voltage comparison circuit 411 generates a logical high signal.

In one embodiment, the current comparison circuit 407 comprises a comparator COM1 having a non-inverting input terminal coupled to the current sense circuit 403 to receive the current sense signal Isense and an inverting input terminal coupled to the multiply circuit 406 to receive the product signal MULO. The voltage comparison circuit 408 comprises a comparator COM2 having a non-inverting input terminal configured to receive the threshold signal Vth, and an inverting input terminal coupled to the zero crossing detect circuit 410 to receive the zero crossing detect signal ZCD. The logic circuit 404 comprises a RS flip-flop FF having a reset terminal coupled to the output terminal of the comparator COM1, a set terminal coupled to the output terminal of the comparator COM2, and an output terminal coupled to the gate terminal of the power switch S1.

When the power switch S1 is turned ON, the transformer T1 stores energy, and the current flowing through the power switch S1 increases. As a result, the current sense signal Isense increases too. At the moment, the zero crossing detect signal ZCD is lower than zero, and the output of the comparator COM2 is logical high. When the current sense signal Isense reaches the product signal MULO, the output of the comparator COM1 becomes logical high to reset the RS flip-flop FF, so as to turn OFF the power switch S1.

When the power switch S1 is turned OFF, no current flows through the power switch S1 and the current sense signal Isense is zero. As a result, the comparator COM1 becomes logical low. The energy stored in the transformer T1 is transferred to the load, i.e., the LED string, via the power diode D1. At the moment, the zero crossing detect signal is larger than zero, and the output of the comparator COM2 is logical low. After all the energy stored in the transformer T1 is transferred to the load, the magnetic inductance of the transformer T1 resonates with the parasitic capacitance of the power switch S1. When the voltage across the power switch S1 hits the valley, which means the zero crossing detect signal ZCD decreases to be lower than the threshold signal Vth, the output of the comparator COM2 becomes logical high, and the RS flip-flop FF is set. As a result, the power switch S1 is turned ON.

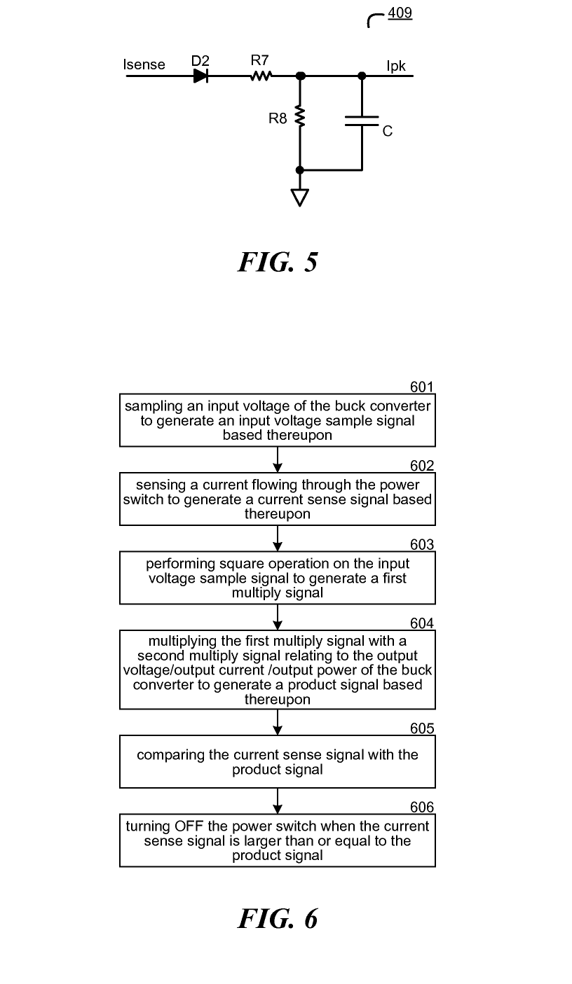

FIG. 5 schematically shows a peak current sample circuit 409 in accordance with an embodiment of the present invention. As shown in FIG. 5, the peak current sample circuit 409 comprises: a diode D2, a first resistor R7, a second resistor R8 and a capacitor C. The diode D2 has an anode terminal coupled to the current sense circuit 403 to receive the current sense signal Isense, and a cathode terminal coupled to a first terminal of the first resistor R7. The second resistor R8 has a first terminal couple to a second terminal of the first resistor R7, and a second terminal coupled to the reference ground. The capacitor C is coupled in parallel with the second resistor R8. The peak current sample circuit 409 samples the peak of the current sense signal Isense to generate a peak current signal Ipk to regulate a current flowing through the LED string.

FIG. 6 shows a flowchart of a method of controlling a step-down switching mode power supply in accordance with an embodiment of the present invention. The step-down switching mode power supply comprises a rectifier and a Buck converter, wherein the Buck converter comprises a power switch and an energy storage component coupled to the power switch. The energy storage component stores or transfers the energy as the power switch is turned ON or OFF. The method comprises steps 601-606, wherein:

Step 601, sampling an input voltage of the Buck converter to generate an input voltage sample signal;

Step 602, sensing a current flowing through the power switch to generate a current sense signal;

Step 603, performing square operation on the input voltage sample signal to generate a first multiply signal;

Step 604, multiplying the first multiply signal with a second multiply signal relating to the output voltage/output current/output power of the Buck converter to generate a product signal;

Step 605, comparing the current sense signal with the product signal;

Step 606, turning OFF the power switch when the current sense signal is larger than or equal to the product signal.

In one embodiment, the method further comprises turning ON the power switch when the current flowing through the energy storage component decreases to zero.

While specific embodiments of the present invention have been provided, it is to be understood that these embodiments are for illustration purposes and not limiting. Many additional embodiments will be apparent to persons of ordinary skill in the art reading this invention.

I/We claim:

1. A step-down switching mode power supply, comprising:
a Buck converter having an input terminal configured to receive an input voltage, an output terminal configured to provide power to a load, and a control terminal configured to receive a control signal to regulate the power provided to the load, wherein the Buck converter comprises a power switch and an energy storage component storing or transferring energy as the power switch is turned ON or OFF;
a current sense circuit coupled to the power switch to generate a current sense signal based on a current flowing through the power switch;
a square circuit having an input terminal configured to receive the input voltage, and an output terminal configured to generate a first multiply signal indicating the squared value of the input voltage;
a multiply circuit having a first input terminal coupled to the square circuit to receive the first multiply signal, a second input terminal configured to receive a second multiply signal, and an output terminal configured to generate a product signal based on the first multiply signal and the second multiply signal;
a current comparison circuit having a first input terminal coupled to the current sense circuit to receive the current sense signal, a second input terminal coupled to the multiply circuit to receive the product signal, and an output terminal configured to generate a current comparison signal based on the current sense signal and the product signal; and
a logic circuit coupled between the output terminal of the current comparison circuit and the control terminal of the Buck converter, wherein the power switch is turned OFF by the logic circuit when the current sense signal is larger than or equal to the product signal.

2. The step-down switching mode power supply of claim 1, wherein the power switch is turned ON when the current flowing through the energy storage component decreases to zero.

3. The step-down switching mode power supply of claim 1, wherein the second multiply signal comprises a compensation signal.

4. The step-down switching mode power supply of claim 3, further comprising:
a peak current sample circuit having an input terminal coupled to the current sense circuit to receive the current sense signal, and an output terminal configured to generate a peak current signal based on the current sense signal; and
an error amplifier having a first input terminal coupled to the peak current sample circuit to receive the peak current signal, a second input terminal configured to receive a reference signal, and an output terminal configured to generate the compensation signal based on the peak current signal and the reference signal.

5. The step-down switching mode power supply of claim 4, wherein the peak current sample circuit comprises:
a diode having an anode terminal and a cathode terminal, wherein the anode terminal is configured to receive the current sense signal;
a first resistor having a first terminal and a second terminal, wherein the first terminal is coupled to the cathode terminal of the diode;
a second resistor having a first terminal and a second terminal, wherein the first terminal coupled to the second terminal of the first resistor and the second terminal coupled to a reference ground; and
a capacitor coupled in parallel with the second resistor.

6. The step-down switching mode power supply of claim 1, further comprising:
a zero crossing detect circuit having an input terminal coupled to the energy storage component to detect the current flowing through the energy storage component, and an output terminal configured to generate a zero crossing detect signal based on the detection; and
a voltage comparison circuit having a first input terminal coupled to the zero crossing detect circuit to receive the zero crossing detect signal, a second input terminal configured to receive a threshold signal, and an output terminal configured to provide a voltage comparison signal.

7. The step-down switching mode power supply of claim 6, wherein the energy storage component comprises a transformer having a primary winding and a secondary winding, and wherein the Buck converter further comprises:
an input capacitor having a first terminal configured to receive the input voltage, and a second terminal coupled to the reference ground;
a power diode having a cathode terminal coupled to the first terminal of the input capacitor, and an anode terminal coupled to the connection node of the energy storage component and the power switch; and
an output capacitor having a first terminal coupled to the cathode terminal of the power diode and a second terminal coupled to a first terminal of the primary winding, wherein the second terminal of the primary winding is coupled to the power switch.

8. The step-down switching mode power supply of claim 1, further comprising an input voltage sample circuit coupled between the input voltage and the square circuit, wherein the input voltage sample circuit samples the input voltage to generate an input voltage sample signal indicating the input voltage to the square circuit, and wherein the square circuit provides the first multiply signal indicating the square value of the input voltage sample signal instead of first multiply signal indicating the square value of the input voltage.

9. A method of controlling a step-down switching mode power supply, wherein the step-down switching mode power supply comprises a Buck converter, and wherein the Buck converter comprises a power switch and an energy storage component configured to store energy or to transfer energy to a load as the power switch is turned ON or OFF, the method comprising:
sampling an input voltage of the Buck converter to generate an input voltage sample signal;
sensing a current flowing through the power switch to generate a current sense signal;
squaring the input voltage sample signal to generate a first multiply signal;
multiplying the first multiply signal with a second multiply signal to generate a product signal based thereupon;
comparing the current sense signal with the product signal; and
turning OFF the power switch when the current sense signal is larger than or equal to the product signal.

10. The method of claim 9, further comprising turning ON the power switch when the current flowing through the energy storage component decreases to zero.

11. The method of claim 9, wherein the second multiply signal comprises a compensation signal.

12. The method of claim 11, further comprising:
sampling the peak of the current sense signal to generate a peak current signal; and
amplifying an error between the peak current signal and a threshold signal to generate the compensation signal.
